(19) United States
(12) Patent Application Publication
(10) Pub. No.: US 2006/0252007 A1
(43) Pub. Date: Nov. 9, 2006

(54) Device for canal preparation

(76) Inventors: Jean-Marie Badoz, Doubs (FR); Jacques Pernot, Vieilley (FR)

Correspondence Address: Cohen Gary M;Strafford Building Number Three, Suite 300, 125 Strafford Avenue, Wayne, PA, 19087-3318, US

(21) Appl. No.: 10/567,169

(22) PCT Filed: May 12, 2004
(86) PCT No.: PCT/FR04/01147

§ 371 Date: Feb. 3, 2006

(30) Foreign Application Priority Data
Aug. 4, 2003 (FR) 03/09593

(51) Int. Cl. A61C 1/12

(52) U.S. Cl. 433/133

(57) ABSTRACT

A canal preparation device comprising a support (1), a treatment instrument (2) equipped with a shank (3), with a contra-angle (4) provided with a head (5), characterized in that the shank (3) of the canal instrument (2) is furnished with a rotational-drive means (6) and in that the head (5) of the contra-angle is provided at its base with a snap-fastening means collaborating with the shank (3) of the rotational-drive means (6) in such a way that, simply by pushing, with the shank (3) of the rotational-drive means (6) engaged in the head, the shank (3) and the head (5) are snap-fastened.

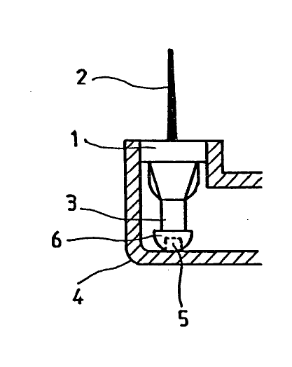

The subject of the present invention is a canal preparation device.

Various instruments for canal preparation are already known from the prior art. These instruments may be used manually or by a mechanical system, by rotating continuously or in a reciprocating manner. They are used for preparing or boring tooth canals.

The rotational movement of this type of instrument is allowed by virtue of a contra-angle piece on which the instrument is positioned. This instrument is generally equipped with a shank, defined by ISO 1797, penetrating the head of the contra-angle, which head is itself provided with mechanical means allowing the instrument to be attached removably.

In this type of instrument of the prior art, the user has to remove the instrument from the shank each time he changes operation, and this increases the risks of prick injury and therefore the risks of contamination as far as the user and the patient are concerned.

Furthermore, the user comes into direct contact with the instrument when fitting it onto the contra-angle. As a result, the instrument is contaminated, thus increasing the risks of microbial growth when treating the tooth canal.

In addition, the means for clamping the instrument onto the contra-angle are bulky, which prevents small-sized heads from being used and therefore restricts the visibility that the user has.

The invention proposes to supply a canal preparation device that allows these various disadvantages to be overcome.

To do this, the subject of the present invention is a canal preparation device comprising a support (1), a treatment instrument (2) equipped with a shank (3), with a contra-angle (4) provided with a head (5), characterized in that the shank (3) of the canal instrument (2) is furnished with a rotational-drive means (6) and in that the head (5) of the contra-angle is provided at its base with a snap-fastening means collaborating with the shank (3) of the rotational-drive means in such a way that, simply by pushing, with the shank (3) of the rotational-drive means (6) engaged in the head, the shank (3) and the head (5) are snap-fastened.

The invention will be better understood with the aid of the description given hereinafter with reference to the attached drawing which depicts a canal preparation device.

The canal preparation device consists of a support (1), for the treatment instruments, and of treatment instruments (2) equipped with a shank (3). These instruments can be interchanged as the user requires.

The shank of the instruments (3) is equipped with a rotational-drive means (6) which, in collaboration with the head (5) of the contra-angle (4), will provide the rotational movement.

According to an advantageous characteristic of the invention, this rotational-drive means (6) will be a pinion.

The head (5) of the contra-angle (4) is provided at its base with a snap-fastening means. The latter will collaborate with the shank of the instrument providing rotation. Thus, simply by pressing, when engaging the shank (3) in the head (5), the instrument becomes firmly attached to the head (5) of the contra-angle (4).

Furthermore, the head (5) of the contra-angle (4) is made of a flexible material which will allow the head (5) to deform at its base.

Thus, when the shank (3) of the instrument is pressed onto the head (5) of the- contra-angle (4), a diamond shape allows the shank of the instrument to pass into the head (5) of the contra-angle (4).

In order to extract the shank (3) of the instrument from the head (5) of the contra-angle (4), all that is required is to press the head (5) along the long diagonal of the diamond, thus releasing the snap-fastening mechanism.

According to an advantageous characteristic of the invention, the blade that constitutes the treatment instruments will be made of steel, which limits costs inasmuchas it will thus be for one use only.

According to another advantageous characteristic of the invention, the head (5) of the contra-angle will also be made of a material that allows one use only.

The canal preparation device according to the invention displays an economical advantage inasmuchas the instruments and the head of the contra-angle are made in such a way that they can be used only once.

Furthermore, the user of this device will avoid contaminating the instruments with his hands inasmuchas the instrument is changed via the head of the contra-angle rather than through direct contact between the user's hand and the blade of the instrument.

Although the invention has been described using particular embodiments, it encompasses all technical equivalents of the means described.

1. A canal preparation device comprising a support (1), a treatment instrument (2) equipped with a shank (3), with a contra-angle (4) provided with a head (5), characterized in that the shank (3) of the canal instrument (2) is furnished with a rotational-drive means (6) and in that the head (5) of the contra-angle (4) is provided at its base with a snap-fastening means collaborating with the shank (3) of the rotational-drive means in such a way that, simply by pushing, with the shank (3) of the rotational-drive means (6) engaged in the head, the shank (3) and the head (5) are snap-fastened.

2. The canal preparation device as claimed in claim 1, characterized in that the head (5) of the contra-angle (4) is made of a material that allows it to deform at its base.

3. The canal preparation device as claimed in one of the preceding claims, characterized in that an oval or diamond shape allows the shank (3) of the instrument (2) to pass when the instrument is pressed onto the head (5) of the contra-angle (4).

4. The canal preparation device as claimed in one of the preceding claims, characterized in that the head (5) has a diamond or oval shape allowing the snap-fastening means to disengage when the head (5) is pressed onto it.

5. The canal preparation device as claimed in one of the preceding claims, characterized in that the instrument (2) may be made of steel.

6. The canal preparation device as claimed in one of the preceding claims, characterized in that the head (5) of the contra-angle (4) is made of a material that allows one use only.

7. The canal preparation device as claimed in one of the preceding claims, characterized in that the rotational-drive means (6) may be a pinion.
